(19) United States
(12) Patent Application Publication
(10) Pub. No.: US 2005/0197988 A1
(43) Pub. Date: Sep. 8, 2005

(54) Adaptive survey and assessment administration using Bayesian belief networks

(76) Inventor: Scott Thomas Bublitz, Durham, NC (US)

Correspondence Address: GRAFFITI PROMOTIONS, LLC, 827 WINDSOR ROAD, ARNOLD, MD, 21012, US

(21) Appl. No.: 10/780,092

(22) Filed: Feb. 17, 2004

(51) Int. Cl. G06F 17/60

(52) U.S. Cl. 706/46; 706/21; 705/10

(57) ABSTRACT

Using Bayesian belief networks to incorporate data from previous experiences to make calculated decision and course of action recommendations, a program was created to incorporate the use of such artificial intelligence systems in the analysis and classifications in the fields of adaptive survey or assessment development and classification systems. In the preferred embodiment, a program was created to categorize work adaptively based on related questions, known relationships, and Bayesian belief networks.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD OF INVENTION

The present invention relates generally to the user of artificial intelligence in the analysis and classification of systems and adaptive assessment developments based on assessment constructs, related questions, and known relationships described in Bayesian belief networks or other probability based model (hereafter referred to as Bbns) using artificial intelligence to incorporate data from previous experiences to make calculated decisions and course of action recommendations. A common type of assessment used in this invention is a questionnaire or survey, but can also be other forms of assessments such as aptitude, interest, personality, or skills-based assessments.

### BACKGROUND OF THE INVENTION

A prototype of this invention was tested to determine if an adaptive survey could improve a commonly used occupational classification system. Occupational classification systems are groupings of all possible job titles in order to describe and distinguish among relevant aspects of occupations. Occupational classification systems often use lengthy surveys to collect data about the duties, requirements, and activities performed within each job. Although classification systems and their surveys are described hereafter, this invention can be applied to any application of surveys or assessments.

Currently occupational classification systems serve three main functions. The first is data collection of occupational statistics that economists and statisticians use for census collection as well as special surveys on worker mobility, technological change, and occupational employment statistics. The hierarchical structure of an occupational classification system assists in comparing and contrasting jobs to develop statistical conclusions based on the data.

The second function of occupational classification systems is for analyzing changes or patterns in the labor force. Organizations use classification systems to understand changes in work force demographics and other important trends to guide employment policies and develop systems for training, recruiting, and job matching. Organizations also use classification systems to draw comparisons across work that, on the surface, may be quite different. These comparisons assist in administrative decisions such as employee placement and the development of salary scales.

The third function of occupational classification systems is for career planning and job seeking. It is important for job seekers, employment counselors, and employers to understand the requirements and opportunities of various occupations. Classification systems can be vocational tools that assist people in finding professions that match their skills and interests. Career guidance counselors can use these systems to educate students or disgruntled workers, for example, on various career paths and duties of each option. By matching the individual's interest and level of knowledge and skill in job-related activities with those of various occupations, potential job seekers can make informed choices on the best career to pursue.

The problem with classifications systems, especially occupation classification systems, is that they are often incapable of adapting to adjustments in structure. For instance, advances in technology and societal changes that occur in relation to the work performed require a revision of the occupational classification system. Because roles within the organization (as well as across the organization) change over time and between organizations, classification systems require continuous review or they will become obsolete. Therefore, occupational classification systems tend to be more descriptive of what existed in the past rather than predictive of trends likely to happen in the future. A tool that allowed for the tracking and updating of changes in job requirements would reduce the large expense of revising the entire classification system.

Although most occupational classification systems have a hierarchical structure that simplifies the process, problems in correctly classifying positions often exist. Frequently, a person classifying a job must choose from several different classifications that are somewhat relevant because there is no single classification that directly applies to the organizational role. In fact, it is possible that the person is not even aware of the relevant classification option because of the size and complexity of the classification system. Without careful consideration of all job aspects, and a thorough examination of the long list of occupations in the system, chances of classification error will exist.

Once the analyst chooses a job classification, he/she must provide ratings on several scales related to the duties and requirements of that position. These ratings can be difficult due to the analyst's lack of familiarity with the occupation. A tool that assists in the accurate classification of positions (as well as in the rating of job duties and requirements) would increase the quality of the decisions based on this information.

Classifying jobs in an occupational classification system requires large amounts of resources. It is very difficult and time-consuming to look through the entire system list to classify the roles of an organization, especially when no documentation of the position exists. First, the organization must create a job description and determine that nature, duties, and responsibilities of the position. Level of education, level of supervision, and other job-relevant jobs factors must be considered in the classification. Once such factors are clearly determined, the person classifying the job must look through the long list of occupations in order to match the duties and requirements of the position with those of a specific group in the classification system. A tool that could assist in the classification of occupations using fewer organizational resources would be beneficial in terms of time and cost savings.

Currently, only people trained in occupational analysis or job taxonomy structures have been able to effectively classify occupations. This process requires the analyst to research the job duties in order to choose the correct classification. In addition, analysts are often burdened with classifying many occupations at once. This burden is exaggerated when analysts must also rate each position in terms of the tasks performed and knowledge, skills, and abilities require for successful job performance. A tool that people other than job analysts to provide input into the process would relieve the analyst from the burden of having to provide all information for each occupation to be classified.

Some occupations are more prevalent in the workforce than others, which affect classification validity. For example, an analyst can more easily rate the duties and requirements of a retail sales position than for a main line station engineer because retail sales is likely to be more familiar to the analyst. Any tool created to assist in occupational classification must be equally accurate regardless of commonality of the job in comparison to others in the classification. In addition, an occupational classification tool must be representative and able to mirror results that occur in reality.

Although current occupational classification systems are useful, the flexibility, accuracy, efficiency, accessibility, and generality of current classification systems continue to be problematic and reduce their effectiveness in organizations. As such, a tool is needed that assists people in classifying occupations and improve the resulting decision quality. Tools using adaptive survey or assessment administration in occupational classification systems will assist organizations in quickly classifying jobs and making decisions based on that classification.

### SUMMARY

The present invention addresses the shortcoming in the prior art with respect to adaptive assessment and survey techniques and technology. In the preferred embodiment, the use of artificial intelligence in the analysis and classification of occupations using Bbns and a web-based program was created to categorize work adaptively based on previous response to work-related questions. In the preferred embodiment, the classification size and shape of prior distribution affect and efficiency and accuracy of classification decisions using an adaptive survey. Results indicate the adaptive survey method was successful at selecting a classification similar to the actual occupation.

This method of adaptive methodology may be used as a foundation or adapted for use in the area of adaptive survey development. Although the preferred embodiment of the present invention focuses on the classification of occupations, it is in no way restricted to this subject area. This methodology would apply to other lengthy assessments or surveys that attempt to classify respondents into groups or categories.

For example, personality inventories attempt to classify individuals into personality types or categories based on their responses to items. By specifying the relationship between these items and personality types, a probability matrix can be created and used as a basis for adaptive administration and potentially reduce the number of items needed for administration. In addition, other areas such as diagnosing illnesses based on patients' symptoms can be helped by using this methodology if the presence of symptoms can help classify illness into distinct categories. Thus, the scope of the invention should be determined by the appended claims and their legal equivalents, rather than by the examples given.

### BRIEF DESCRIPTION OF THE DRAWINGS

FIG. 1 illustrates the first step of the present invention;

FIG. 2 illustrates the second step of the present invention;

FIG. 3 illustrates the third step of the present invention;

FIG. 4 illustrates the optional fourth step of the present invention;

FIG. 5 illustrates the underlying artificial intelligence of adaptive survey technology;

FIG. 6 illustrates the relationship between survey questions and possible responses;

FIG. 7 illustrates probability updates in response to a given answer to a survey questions;

FIG. 8 illustrates probability updates in response to a different answer to the survey questions;

FIG. 9 illustrates probability updates in response to yet another different answer to the survey questions.

### DETAILED DESCRIPTION OF THE INVENTION

A Bayesian belief network or other probability based model (hereafter referred to as a Bbn) is a graphical representation of believed relations (which may be uncertain, stochastic, or imprecise) between a set of variables that are relevant to solving some problem. A Bbn's utility is most apparent when solving very complex problems. While it is conceivable that someone could mentally make a decision involving the interrelationship of ten or more variables, as more variables are included, the number of parameters needs to be calculated increases exponentially, making a mental decision process quite difficult.

A Bbn consists of a set of variables (nodes) and linkages (links) depicting their interrelationship. The goal of the present invention is to use previous related information to predict an outcome when considering a large number of variables in a complex situation. In the preferred embodiment of the present invention, an adaptive occupational classification survey program is used to predict which classification best describes the work performed based on previous job related information.

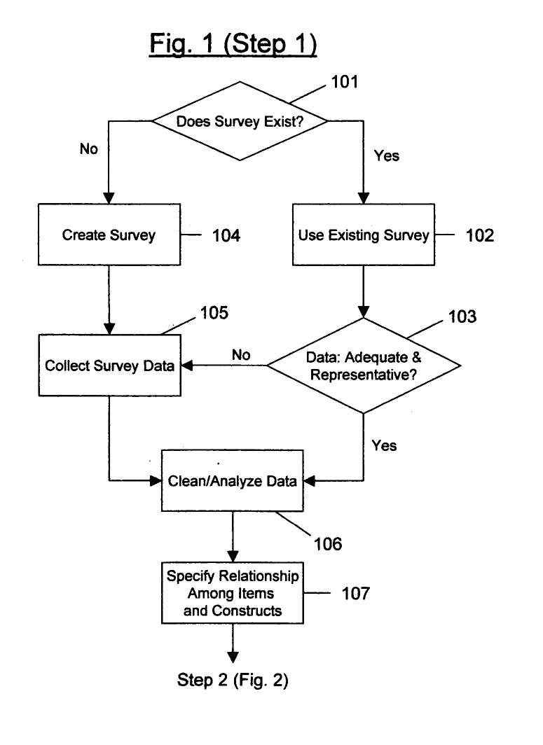

Now referring to FIGS. 1-4, there will be four steps in the creation of an adaptive assessment or survey program. The first step is to collect assessment or survey data in a small pilot administration (or use existing data) to specify relationships among questions and the underlying constructs. The second step is utilizing the relationships calculated in the first step to create a probability distribution contained in a Bbn or other probability-based model. The third step is running a simulation using adaptive branching structure for controlling the administration of questions to each individual respondent to determine the applicability of adaptive administration. Once the adaptive program has been successfully tested and use begins, the fourth step describes how the data collected from respondents can be automatically incorporated back into the Bbn to allow for continuous model improvement (i.e., learning).

Referring to Step 1 (FIG. 1), the first process (101) involves a decision regarding whether or not a survey or assessment currently exists to measure the construct of interest. If a survey or assessment exists, the adaptive program can use any or all available survey questions (102). If a survey does not exist, the researcher can create the survey, including defining all assessment or survey constructs and developing all relevant questions (104). For existing assessment or surveys, the researcher will make a determination about whether the existing dataset is adequate and representative of the population for which it will be used (103). If the data is adequate and representative, it will be cleaned and analyzed (106).

If the data is not adequate or representative (or the survey has never been administered to the population of interest), the assessment or survey will be administered to a small pilot sample of respondents (105) using assessment administration software. The number of respondents in the pilot sample is determined by the number of distinctions needed in the construct of interest. For example, a construct consisting of a yes/no decision (whether or not to market a new product) will require fewer respondents than constructs with many levels (selecting an ideal occupation for respondents among a list of 1100 jobs).

Any software program capable of survey or assessment administration with the ability to accept survey or assessment related information from a respondent or other external source via a web browser, computer terminal, or telephone would be interchangeable with the specific program discussed herein. After the pilot administration, the resulting dataset will be cleaned and analyzed (106). The resulting dataset (along with expert opinion) will be used to determine the relationship between assessment or survey questions and the underlying constructs (107).

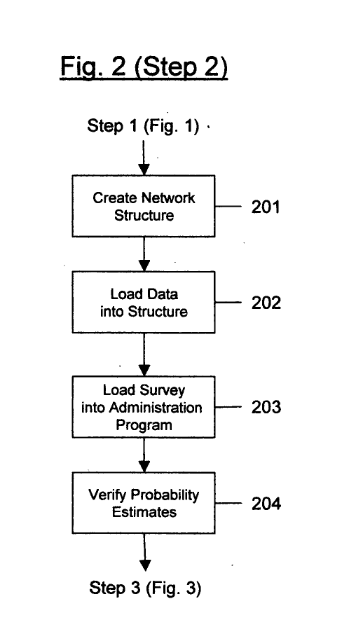

Referring to Step 2 (FIG. 2), the first process involves using the relationships specified in Step 1 (107) to create the structure for the Bbn or other probability-based model (201) using software such as Netica, Hugin Expert, Genie, BUGS, or other software for calculating the probabilities associated with each of the items. This structure will specify the relationship between all items and constructs. Once the structure is specified, the survey or assessment data from Step 1 (106) can be incorporated into the probability-based structure (202). The next process involves loading the survey items into a database to be used by the survey administration software (203). Any software program capable of adaptive survey or assessment administration with the ability to accept survey or assessment related information from a respondent or other external source via a web browser, computer terminal, or telephone would be interchangeable with the specific program discussed herein. The final process in Step 2 is a quality control check to verify that the probabilities have been appropriately specified in the Bbn or other probability-based model (204).

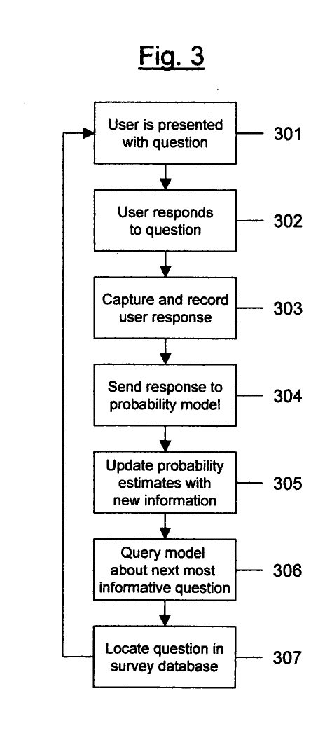

Step 3 (FIG. 3), describes the administration process, and interaction between the user, the adaptive survey or assessment administration software, and the Bbn (or other probability based model). For the purposes of this invention, the user can be either the survey or assessment respondent, or someone entering the information on the respondent's behalf Initially, the user is presented with a survey or assessment question (301) via a web browser, computer terminal, or telephone. The user responds to the question (302), and their response is sent back to the adaptive administration program. The adaptive administration program captures and records the response in a database (303). In addition, the probability model also receives the user's response (304) through an Application Programmer's Interface (API). The probability estimates in the model are updated to incorporate the user's response (305). After updating the probabilities, the adaptive administration program makes a determination about the next question to present to the user. This determination is made by querying the model (306) to find out which of the remaining questions would provide the most information about the underlying construct or set of constructs. This query can use an entropy function, variance reduction function, or other mathematical algorithm to make the determination. The next process in Step 3 is to locate the next most informative question in the survey database (307) and present it back to the user (301), and the process repeat with the user's response to the next question. Step 3 is a cyclical procedure that continues until either a predetermined confidence level of the underlying construct(s) has been exceeded or all questions in the survey database have been presented.

The adaptive administration software will automatically update the probability information after each response to predict the respondent's opinion about possible courses of action related to the development, administration, and analysis of surveys and assessments. The adaptive survey or assessment software is capable of reporting to the respondent the most probable responses of survey questions for which they did not respond. Additionally, the adaptive survey or assessment software that is capable of reporting to the respondent the most probable course(s) of action related to the development, administration, and analysis of surveys and assessments.

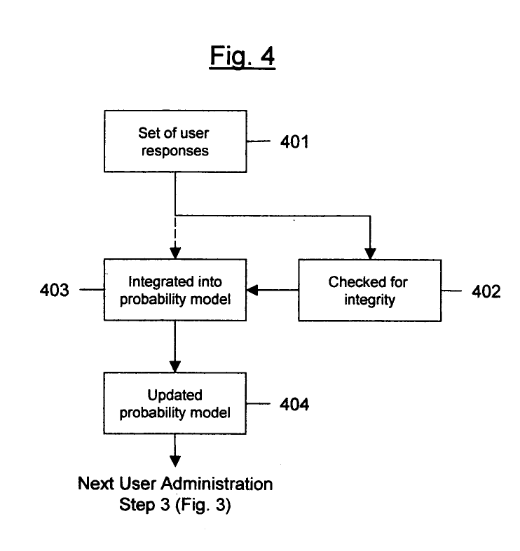

Following the survey or assessment administration of one user (or set of users), their set of responses can be incorporated into the model to improve the accuracy of probability estimates for future respondents. This step, described in FIG. 4, is optional and should be used after verifying the data integrity. This step can be performed periodically (i.e., after administering to a group of users) or automatically after each user. The first process in this step involves collecting the set of user responses (401) obtained from survey or assessment administration (Step 3). This set of responses can be checked for integrity using manual visual inspection or automatic validation procedures (402). Alternatively, the data can be automatically integrated into the probability model (403) immediately after completion of the survey or assessment. The result will be an updated Bbn or other probability-based model (404) that uses previous user data to increase the precision of probability estimates.

In a preferred embodiment, this method is implemented to create an adaptive occupational analysis and classification system. Within the system, questionnaires are developed or other databases are used to collect data covering any number of classifications and content areas. An occupational system such as O*Net (Occupational Information Network, U.S. Dept. of Labor) may be selected to attempt to provide a database application to classify occupations as well as describe their duties and requirements and provide data for the content areas.

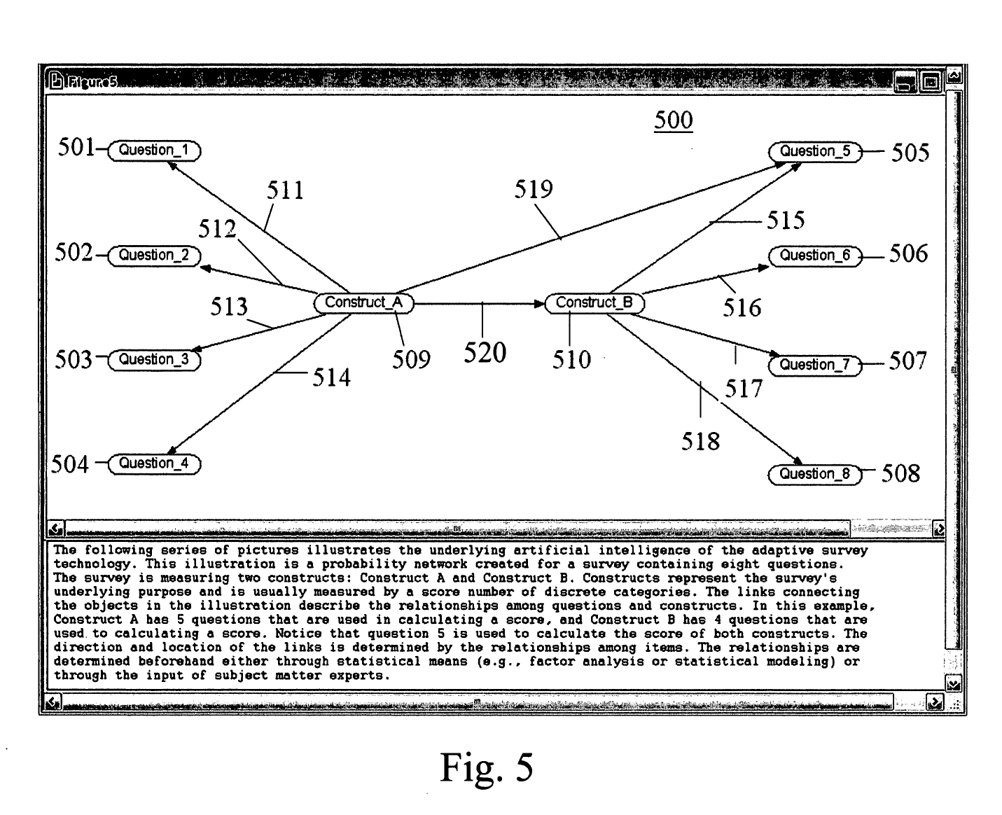

The following series of pictures illustrates the underlying artificial intelligence of the adaptive survey or assessment administration technology. Now referring to FIG. 5 this illustration is a probability network (500) created for a survey containing eight questions (501-508). The survey is measuring two constructs: Construct A (509) and Construct B (510). Constructs A & B (509 & 510) represent the survey or assessment's purpose and is usually measured by a score number of discrete categories. The links (511-520) connecting the objects in the illustration describe the relationships among questions and constructs. In this example, Construct A (509) has five questions (501-504) that are used in calculating a score, and Construct B (510) has four questions (505-508) that are used to calculate a score. Notice that question five (505) is used to calculate the score of both Constructs A and B (509 & 510) as illustrated by a link (519) from Construct A (509) and a link (515) from Construct B (510) to Question 5 (505). The direction and location of the links (511-520) is determined by the relationships among the questions and constructs. These relationships are determined beforehand either through statistical means (e.g., factor analysis or statistical modeling) or through the input of subject matter experts.

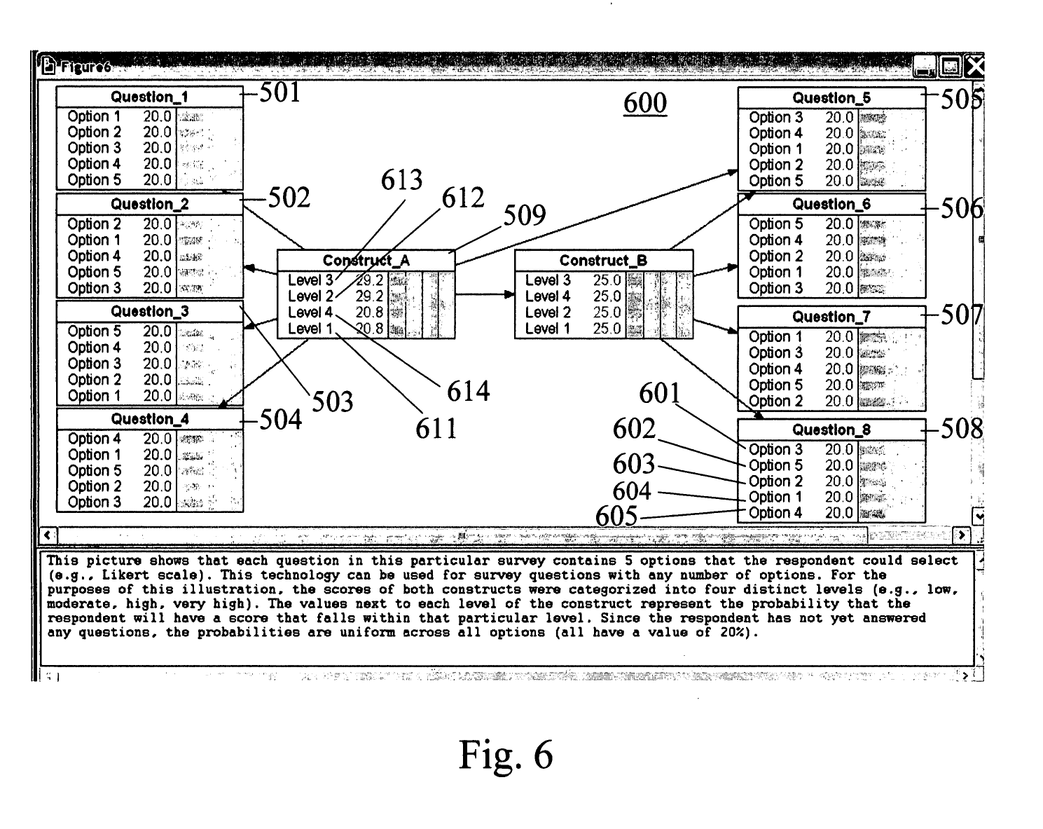

Now referring to FIG. 6 this illustrates how each of the questions (501-508) in this particular survey contains five options, while all options for each questions are illustrated (600). For simplification purposes FIG. 6 shows illustrates the five survey answers options (601-605) that the user could select (e.g., Likert scale) for question 8 (508). This technology can be used for survey questions with any number of options. For the purposes of this illustration, the scores of both constructs (509 & 510) were categorized into four distinct levels; i.e. low (611), moderate (612), high (613), very high (614). The values next to each level of the construct (and the options for each question) represent the probability that the user will have a score that falls within that particular level (or option). Since the user has not yet answered any questions, the probabilities are uniform across all options (all have a value of 20%).

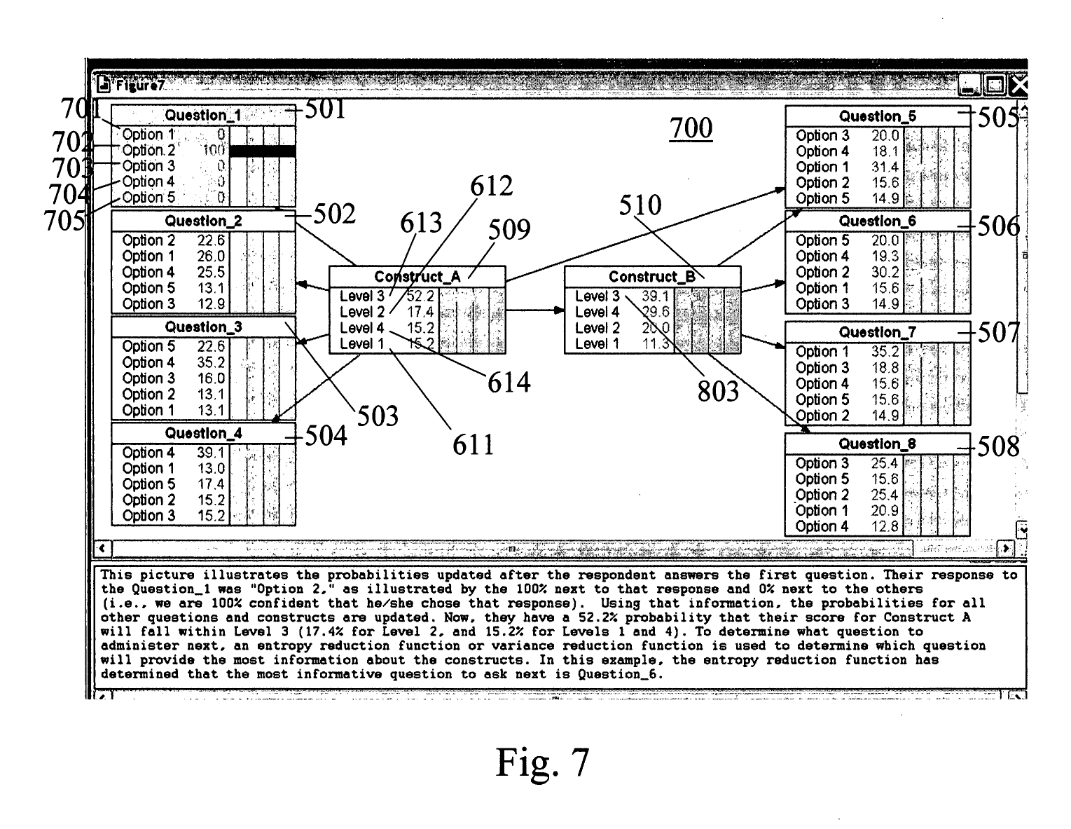

FIG. 7 illustrates the probabilities updated (700) after the respondent answers the first question (501). Their response to the Question 1 (501) was “Option 2,” (702) as illustrated by the 100% next to that response and 0% next to the others (701, 703-705) (i.e., we are 100% confident that he/she chose that response). Using that information, the probabilities for all other questions (501-508) and constructs A &B (509-510) are updated. Now, the user has a 52.2% probability that his/her score for Construct A (509) will fall within Level 3 (613), 17.4% for Level 2 (612), and 15.2% for Level 1 (611) and Level 4 (614). To determine what question to administer next, an entropy reduction function or variance reduction function is used to determine which question will provide the most information about the constructs. These functions will use all previous responses to determine which of the remaining questions will provide the most information (or reduce the variance) of the underlying construct(s). In other words, given (1) the user's responses to previous questions and (2) the relationship among items and constructs as defined by the probabilistic model, which of the remaining questions will provide the most information about the underlying construct(s)? In this example, the entropy reduction function has determined that the most informative question to ask next is Question 6 (506).

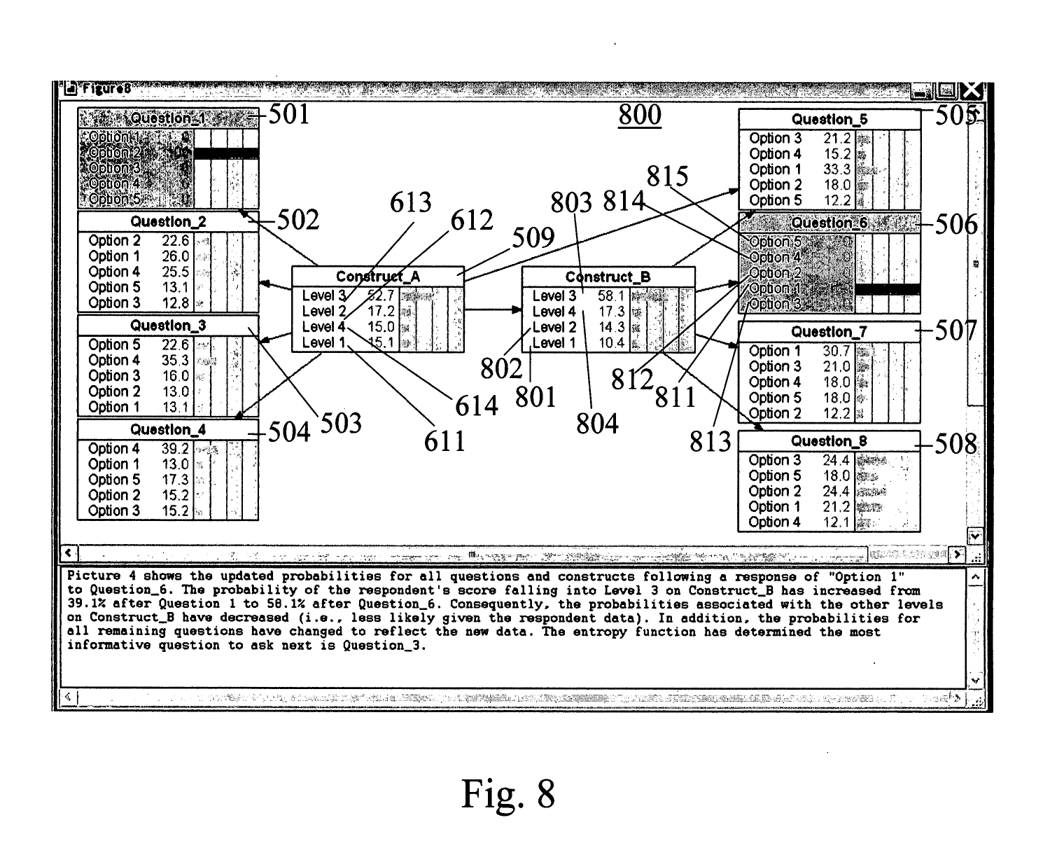

FIG. 8 illustrates the updated probabilities (800) for all questions (501-508) and constructs (509 & 510) following a response of “Option 1” (810) to Question 6 (506). The probability of the user's score falling into level 3 (803) on Construct B (510) has increased from 39.1% after Question 1 (501) to 58.1% after Question 6 (506). Consequently, the probabilities associated with the other levels (801-804) on Construct B (510) have decreased (i.e., less likely given the user data). In addition, the probabilities for all remaining questions (502-505 and 507-508) have changed to reflect the new data. The entropy function has determined the most informative question to ask next is Question 3 (503).

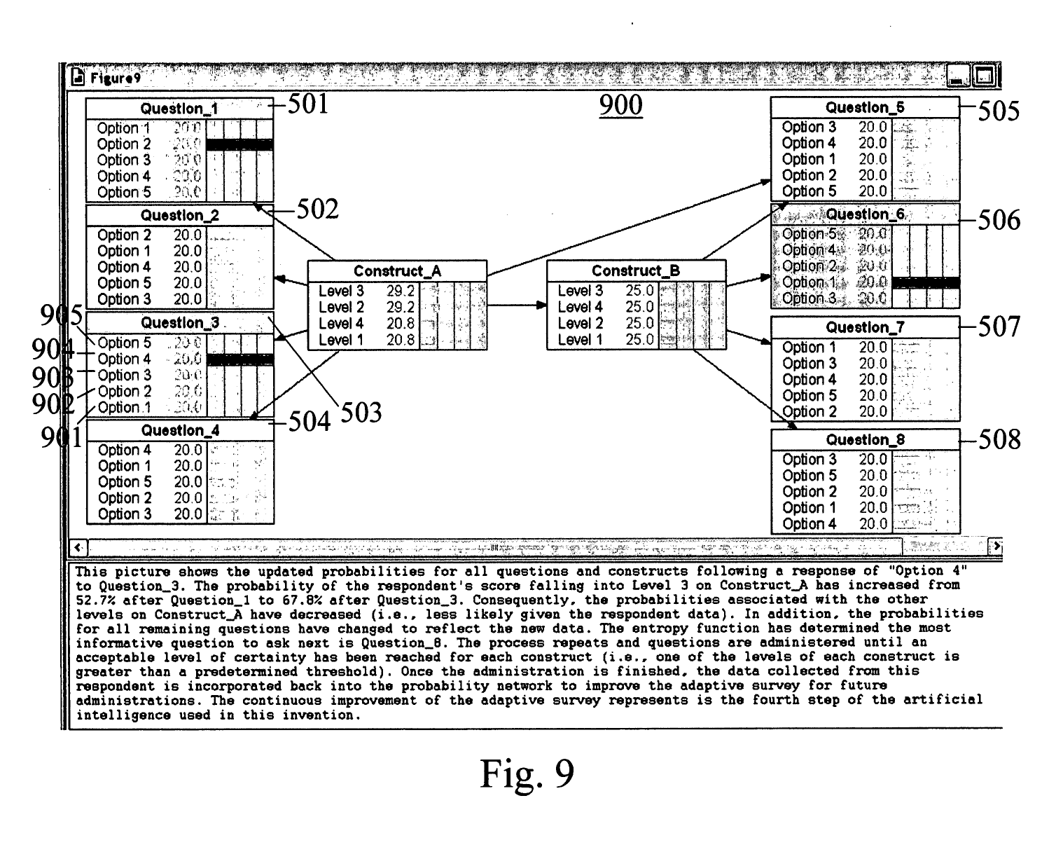

FIG. 9 illustrates the updated probabilities (900) for all questions (501-508) and constructs (509 & 510) following a response of “Option 4” (904) to Question 3 (503). The probability of the user's score falling into Level 3 (613) on Construct A (509) has increased from 52.7% after Question 1 (501) to 67.8% after Question 3 (503). Consequently, the probabilities associated with the other levels (611, 612, and 614) on Construct A (509) have decreased (i.e., less likely given the user data). In addition, the probabilities for all remaining questions (501-508) have changed to reflect the new data. The entropy function has determined the most informative question to ask next is Question 8 (508). The process repeats and questions are administered until an acceptable level of certainty has been reached for each constructs A & B (509 & 510) (i.e., one of the levels of each construct is greater than a predetermined threshold).

In one preferred embodiment, O*NET was used as a database to provide the necessary data such as job classifications (also referred to as occupational units or OUs). Each job classification had a corresponding rating for each content component. This method of adaptive methodology may be used as a foundation or adapted for use in the area of adaptive survey or assessment development. Although the preferred embodiment of the present invention focuses on the classification of occupations, it is in no way restricted to this subject area. This methodology would apply to other lengthy surveys that attempt to classify into groups or categories. For example, personality inventories attempt to classify individuals into personality types or categories based on their responses to items. By specifying the relationship between these items and personality types, a probability matrix can be created and used as a basis for adaptive administration and potentially reduce the number of items needed for administration.

In addition, other areas such as: Product Development, Customer Feedback, Career Counseling, Medical Diagnosis, Census and Public Polling, Technical Support Systems, Employee Feedback, Market Research, Skills Assessment, and Education Evaluation are easily adapted to benefit from adaptive survey or assessment technology by merely changing the source of survey or assessment response data (e.g., previous survey administrations, pilot sample, expert opinion).

For example, to create an adaptive survey or assessment for product development one could use a source of product development information such as customers, competitors, market research, employees, vendors, or resellers. For customer feedback, one could use a source of customer-related information such as customers, industry analysts, vendors, employees, or resellers. For medical diagnosis, one could use a source of patient symptom and medical history information such as nurse, physician, patient, or a relative. For career counseling, one could use a source of career counseling or vocational information such as school or vocational counselors, occupational therapists, students, teachers, or parents. For census and public polling, one could use a source of census data and public opinion, interest, value, or intention information. For technical support systems for electronic devices and computers, one could use a source of information on the symptoms and circumstances surrounding technical problems. For employee feedback, one could use a source of information on worker attitudes and opinions such as employees, supervisors, subordinates, peers, or consultants. For market research, one could use a source of market-specific data such as analysts, previous market research, indices, or organizations. For employee skill assessment one could use a source of information of the individual's skill set such as self-report, supervisors, peers, or performance tests. For educational evaluation, one could use a source of information related to the effectiveness of educational initiatives such as students, parents, teachers, or administrators.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Thus, the scope of the invention should be determined by the appended claims and their legal equivalents, rather than by the examples given.

1. A method of adaptive survey or assessment systems used to collect information related to the development, administration, and analysis of surveys and assessments comprising:
a source of survey or assessment response data (e.g., previous survey administrations, pilot sample, expert opinion);
a software program capable of adaptive survey or assessment administration via a web browser or computer terminal with the ability to accept survey or assessment related information from a respondent or other external source;
the adaptive survey or assessment software containing with a database survey questions relevant to the development, administration, and analysis of surveys and assessments;
a Bayesian belief network or other probability-based model containing probability information created by a software program to assist in survey or assessment related decisions;
the adaptive survey or assessment software that automatically updates the probability information after each response to predict the user's opinion about possible courses of action related to the development, administration, and analysis of surveys and assessments;
the adaptive survey or assessment software that uses responses to previous questions to automatically determine the most informative question to ask next;
the adaptive survey or assessment software that continues adaptively administering questions until a predetermined probability-based confidence level has been reached;
the adaptive survey or assessment software that is capable of reporting to the user or sponsoring organization the most probable responses of survey questions for which they did not respond;
the adaptive survey or assessment software that is capable of reporting to the user or sponsoring organization the most probable course(s) of action related to the development, administration, and analysis of surveys and assessments.

2. The method of claim 1 further comprising the steps of:
first step of determining the relationship among survey questions and their underlying constructs using either previously collected data or a small pilot administration;
second step of using the relationships calculated in first step to create a probability distribution contained in a Bayesian belief network or other probability-based model;
third step of running a simulation using adaptive branching structure for controlling the administration of questions to each user to determine the applicability of adaptive administration;
optional fourth step of incorporating the user data back into the probability model to improve accuracy of probability estimates.

3. The method of claim 2 further comprising:
the probability-based information is related to survey or assessment related classification.

4. The method of claims 1, 2, or 3 further comprising:
the method of adaptive survey or assessment systems is used to collect information is related to product development and/or its introduction into one or more markets comprising:
a source of product development information (e.g., customers, competitors, market research, employees, vendors, resellers);
where the adaptive survey or assessment software contains a database survey questions relevant to product development and/or its introduction into one or more markets;
the Bayesian belief network or other probability-based model containing probability information created by a software program to assist in product development and market decisions;
the adaptive survey or assessment software automatically updates the probability information after each response to predict the survey user's opinion about possible courses of action related to product development and/or its introduction into one or more markets;
the adaptive survey or assessment software is capable of reporting back to the user or sponsoring organization the most probable course(s) of action related to product development and/or its introduction into one or more markets the probability-based information is related to product development and market classification.

5. The method of claims 1, 2, or 3 further comprising:
the method of adaptive survey or assessment systems is used to collect information related to customer interests, values, preferences, and intentions comprising:
a source of customer-related information (e.g., customers, industry analysts, vendors, employees, resellers);
the software program capable of adaptive survey or assessment administration with the ability to accept customer satisfaction or other customer-related information from a user or other external source via a web browser or computer terminal;
the adaptive survey or assessment software containing with a database survey questions relevant to customer interests, values, preferences, and intentions; the Bayesian belief network or other probability-based model containing probability information created by a software program to assist in customer satisfaction or other customer-related decisions;
the adaptive survey or assessment software that automatically updates the probability information after each response to predict the survey user's opinion about possible courses of action related to customer interests, values, preferences, and intentions;
the adaptive survey or assessment software that is capable of reporting back to the user or sponsoring organization the most probable course(s) of action related to customer interests, values, preferences, and intentions;
the probability-based information is related to customer satisfaction or other customer-related classification.

6. The method of claims 1, 2, or 3 further comprising:
the method of adaptive survey or assessment systems used to collect information related to diagnosing or treating medical illness or pathology comprising:
a source of patient symptom and medical history information (e.g., nurse, physician, patient, relative);
the software program capable of adaptive survey or assessment administration with the ability to accept medical diagnostic or treatment related information from a user or other external source via a web browser or computer terminal;
the adaptive survey or assessment software containing with a database survey questions relevant to diagnosing or treating medical illness or pathology;
the Bayesian belief network or other probability-based model containing probability information created by a software program to assist in medical diagnostic or treatment related decisions;
the adaptive survey or assessment software that automatically updates the probability information after each response to predict the survey user's opinion about possible courses of action related to diagnosing or treating medical illness or pathology;
the adaptive survey or assessment software that is capable of reporting back to the user or sponsoring organization the most probable course(s) of action related to diagnosing or treating medical illness or pathology;
the probability-based information is related to medical diagnostic or treatment related classification.

8. The method of claims 1, 2, or 3 further comprising:
the method of adaptive survey or assessment systems used to collect information related to career exploration and/or vocational guidance comprising:
a source of career counseling or vocational information (e.g., school or vocational counselors, occupational therapists, students, teachers, parents);
the software program capable of adaptive survey or assessment administration with the ability to accept career or vocational related information from a user or other external source via a web browser or computer terminal;
the adaptive survey or assessment software containing with a database survey questions relevant to career exploration and/or vocational guidance;
the Bayesian belief network or other probability-based model containing probability information created by a software program to assist in career or vocational related decisions;
the adaptive survey or assessment software that automatically updates the probability information after each response to predict the survey user's opinion about possible courses of action related to career exploration and/or vocational guidance;
the adaptive survey or assessment software that is capable of reporting to the user the most probable course(s) of action related to career exploration and/or vocational guidance;
the probability-based information is related to career or vocational related classification.

9. The method of claims 1, 2, or 3 further comprising:
the method of adaptive survey or assessment systems used to collect information related to census collection and polling surveys of public opinion comprising:
a source of census data and public opinion, interest, value, or intention information;
the software program capable of adaptive survey or assessment administration with the ability to accept census and public opinion related information from a user or other external source via a web browser or computer terminal;
the adaptive survey or assessment software containing with a database survey questions relevant to census collection and polling surveys of public opinion;
the Bayesian belief network or other probability-based model containing probability information created by a software program to assist in census and public opinion related decisions;
the adaptive survey or assessment software that automatically updates the probability information after each response to predict the survey user's opinion about possible courses of action related to census collection and polling surveys of public opinion;
the adaptive survey or assessment software that is capable of reporting back to the user or sponsoring organization the most probable course(s) of action related to census collection and polling surveys of public opinion;
the probability-based information is related to census and public opinion related classification.

10. The method of claims 1, 2, or 3 further comprising:
the method of adaptive survey or assessment systems used to collect information related to systems that assist in troubleshooting solving technical and complex issues comprising:
a source of information on the symptoms and circumstances surrounding technical problems;
the software program capable of adaptive survey or assessment administration with the ability to accept technical support related information from a user or other external source via a web browser or computer terminal;
the adaptive survey or assessment software containing with a database survey questions relevant to systems that assist in troubleshooting solving technical and complex issues;
the Bayesian belief network or other probability-based model containing probability information created by a software program to assist in technical support related decisions;
the adaptive survey or assessment software that automatically updates the probability information after each response to predict the survey user's opinion about possible courses of action related to systems that assist in troubleshooting solving technical and complex issues;
the adaptive survey or assessment software that is capable of reporting back to the user or sponsoring organization the most probable course(s) of action related to systems that assist in troubleshooting solving technical and complex issues;
the probability-based information is related to technical support related classification.

11. The method of claims 1, 2, or 3 further comprising:
the method of adaptive survey or assessment systems used to collect information related to employee attitudes, interests, preferences, and opinions comprising:
a source of information on worker attitudes and opinions (e.g., employees, supervisors, subordinates, peers, consultants);
the software program capable of adaptive survey or assessment administration with the ability to accept employee feedback related information from a user or other external source via a web browser or computer terminal;
the adaptive survey or assessment software containing with a database survey questions relevant to employee attitudes, interests, preferences, and opinions;
the Bayesian belief network or other probability-based model containing probability information created by a software program to assist in employee feedback related decisions;
the adaptive survey or assessment software that automatically updates the probability information after each response to predict the survey user's opinion about possible courses of action related to employee attitudes, interests, preferences, and opinions;
the adaptive survey or assessment software that is capable of reporting back to the user or sponsoring organization the most probable course(s) of action related to employee attitudes, interests, preferences, and opinions;
the probability-based information is related to employee feedback related classification.

12. The method of claims 1, 2, or 3 further comprising:
the method of adaptive survey or assessment systems used to collect information related to the description or prediction of market performance and conditions comprising:
a source of market-specific data (e.g., analysts, previous market research, indices, organizations);
the adaptive survey or assessment software containing with a database survey questions relevant to the description or prediction of market performance and conditions;
the Bayesian belief network or other probability-based model containing probability information created by a software program to assist in market research related decisions;
the adaptive survey or assessment software that automatically updates the probability information after each response to predict the survey user's opinion about possible courses of action related to the description or prediction of market performance and conditions;
the adaptive survey or assessment software that is capable of reporting back to the user or sponsoring organization the most probable course(s) of action related to the description or prediction of market performance and conditions; the probability-based information is related to market research related classification.

13. The method of claims 1, 2, or 3 further comprising:
the method of adaptive survey or assessment systems used to collect information related to the assessment and quantification of an individual's skill set comprising:
a source of information of the individual's skill set (e.g., self-report, supervisors, peers, performance tests);
the adaptive survey or assessment software containing with a database survey questions relevant to the assessment and quantification of an individual's skill set;
the Bayesian belief network or other probability-based model containing probability information created by a software program to assist in skills assessment related decisions;
the adaptive survey or assessment software that automatically updates the probability information after each response to predict the survey user's opinion about possible courses of action related to the assessment and quantification of an individual's skill set;
the adaptive survey or assessment software that is capable of reporting back to the user or sponsoring organization the most probable course(s) of action related to the assessment and quantification of an individual's skill set;
the probability-based information is related to skills assessment related classification.

14. The method of claims 1, 2, or 3 further comprising:
the method of adaptive survey or assessment systems used to collect information related to the evaluation of educational instructors, courses, and institutions comprising:
a source of information related to the effectiveness of educational initiatives (e.g., students, parents, teachers, administrators);
the adaptive survey or assessment software containing with a database survey questions relevant to the evaluation of educational instructors, courses, and institutions;
the Bayesian belief network or other probability-based model containing probability information created by a software program to assist in educational assessment related decisions;
the adaptive survey or assessment software that automatically updates the probability information after each response to predict the survey user's opinion about possible courses of action related to the evaluation of educational instructors, courses, and institutions;
the adaptive survey or assessment software that is capable of reporting back to the user or sponsoring organization the most probable course(s) of action related to the evaluation of educational instructors, courses, and institutions;
the probability-based information is related to educational assessment related classification.
